(19) United States
(12) Patent Application Publication
(10) Pub. No.: US 2005/0235022 A1
(43) Pub. Date: Oct. 20, 2005

(54) Digital filter apparatus and filter processing method thereof

(75) Inventor: Hiroyuki Kogure, Gunma-ken (JP)

Correspondence Address: SoCAL IP LAW GROUP LLP, 310 N. WESTLAKE BLVD. STE 120, WESTLAKE VILLAGE, CA, 91362, US

(73) Assignee: Sanyo Electric Co., Ltd., Osaka (JP)

(21) Appl. No.: 11/111,356

(22) Filed: Apr. 20, 2005

(30) Foreign Application Priority Data
Apr. 20, 2004 (JP) 2004-124417

(51) Int. Cl. G06F 17/10

(52) U.S. Cl. 708/300

(57) ABSTRACT

A digital filter apparatus into which a digital input signal of plural bits is inputted in each predetermined period and which outputs a digital output signal that is a result of filter-processing the digital input signal in accordance with a predetermined filter coefficient and filter order. The digital filter apparatus comprises a delay processing unit to sequentially delay the digital input signal and/or the digital output signal in said each period in accordance with the filter order; a filter coefficient processing unit to shift down, by an equal number of bits to the absolute value of an exponent represented by a position of “1” in a decimal portion of the filter coefficient that becomes a finite decimal when expressed in binary notation, each of the digital input signal and delayed signals processed by the delay processing unit; and an addition processing unit that adds the signals processed by the filter coefficient processing unit and outputs the adding result as the digital output signal.

### CROSS-REFERENCE TO RELATED APPLICATIONS

The present application claims priority upon Japanese Patent Application No. 2004-124417 filed on Apr. 20, 2004, which is herein incorporated by reference.

### BACKGROUND OF THE INVENTION

1. Field of the Invention

The present invention relates to a digital filter apparatus and to a filter processing method thereof.

2. Description of the Related Art

A digital filter apparatus processes a digital signal of a quantifying bit number inputted per predetermined sampling period, and removes/extracts a predetermined frequency component included in the digital signal by filter processing in accordance with a predetermined filter coefficient and filter order. For example, a digital filter apparatus may be constituted by a finite impulse response (FIR) filter or an infinite impulse response (IIR) filter.

Incidentally, the transfer function H(Z) of a digital filter apparatus is expressed by the sum product of the filter coefficients h (1) to h(n) and the delay signals Z\hat{ }(−1) to Z\hat{ }(−n), such as “H(Z)=h(1)·Z\hat{ }(−1)+h(2)·Z\hat{ }(−2)+ . . . h(n)·Z\hat{ }(−n). For this reason, there are many instances where the digital filter apparatus is implemented by a digital signal processor (DSP) capable of high-speed multiplication accumulation.

FIG. 12 is a block diagram of an n-order IIR filter implemented by a DSP. As shown in FIG. 12, the IIR filter comprises coefficient registers 90 and 93, delay registers 91 and 94, multipliers 92 and 95, and an adder 96.

The coefficient registers 90 are registers that store filter coefficients a0 to an, and the coefficient registers 93 are registers that store filter coefficients b1 to bn. The delay registers 91 are registers for delaying a digital input signal X(Z) by one sampling period, and the delay registers 94 are registers for delaying a digital output signal Y(Z) by one sampling period.

The multipliers 92 multiply by the filter coefficients a0 to an stored in the coefficient registers 90 respectively the digital input signal X(Z) and the signals delayed by the delay registers 91. The multipliers 95 multiply by the filter coefficients b1 to bn stored in the coefficient registers 93 respectively the signals delayed by the delay registers 94. The adder 96 adds together the results multiplied in the multipliers 92 and 95, and outputs the digital output signal Y(Z).

Due to the above configuration, the transfer function H(Z) of the IIR filter shown in FIG. 12 is expressed as “H(Z)={a0+a1·Z\hat{ }(−1)+ . . . an·Z\hat{ }(−n)}/{1+b1·Z\hat{ }(−1)+ . . . bn·Z\hat{ }(−n)}”. It will be noted that in the configuration shown in FIG. 12, an n-order FIR filter can be expressed as an instance not including the coefficient filters 93, the delay registers 94 and the multiplier 95 pertaining to the recursive portion of the digital output signal Y(Z). For example, see Japanese Patent Application Laid-open Publication No. 2003-179466.

When a conventional digital filter apparatus such as shown in FIG. 12 is configured by a DSP, the circuit scales of the multipliers are extremely large in comparison to the circuit scales of other circuit elements; sometimes the ratio occupied by the multipliers is 50% of the total circuit scale of the DSP. For example, a common multiplier is realized by partial product generating circuits for generating the partial products of the multiplicand data and the multiplier data and an adder for accumulating and adding the partial products. Here, because the partial product generating circuits and the adder have circuit scales corresponding to the number of bits of the multiplicand data and the multiplier data, the number of partial products naturally increases when the number of bits of the multiplicand data and the multiplier data is increased. As a result, the circuit scale of the entire DSP becomes dramatically larger. Namely, it has been difficult to integrate a conventional digital filter apparatus into a DSP or the like due to the circuit scale of the multiplier.

There are also many instances where a DSP is configured with emphasis on generality, for example to enable the filter coefficients stored in the coefficient registers 90 and 93 shown in FIG. 12 to be changed as needed. However, with a digital filter apparatus or the like designed for a specific purpose, there is not much of a need to put emphasis on generality because the required filter characteristics are often basically limited. Namely, there has been the potential for conventional digital filter apparatuses to have an unnecessarily redundant configuration.

### SUMMARY OF THE INVENTION

In order to solve the above and other problems, one aspect of the present invention provides a digital filter apparatus into which a digital input signal of plural bits is inputted in each predetermined period and which outputs a digital output signal that is a result of filter-processing the digital input signal in accordance with a predetermined filter coefficient and filter order, the digital filter apparatus comprising a delay processing unit to sequentially delay the digital input signal and/or the digital output signal in said each period in accordance with the filter order; a filter coefficient processing unit to shift down, by an equal number of bits to the absolute value of an exponent represented by a position of “1” in a decimal portion of the filter coefficient that becomes a finite decimal when expressed in binary notation, each of the digital input signal and delayed signals processed by the delay processing unit; and an addition processing unit that adds the signals processed by the filter coefficient processing unit and outputs the adding result as the digital output signal.

According to the present invention, a digital filter apparatus that does not need a multiplier and is suited for integration, and a filtering method thereof, can be provided.

### BRIEF DESCRIPTION OF THE DRAWINGS

For a more complete understanding of the present invention and the advantages thereof, reference is now made to the following description taken in conjunction with the accompanying drawings wherein:

FIG. 1 is diagram describing a method of configuring a digital filter apparatus according to an embodiment of the invention;

FIG. 2 is a block diagram describing a simple model according to an embodiment of the invention;

FIG. 3 is a block diagram of a digital filter apparatus according to an embodiment of the invention;

FIG. 4 is a diagram describing a method of configuring a digital filter apparatus according to an embodiment of the invention;

FIG. 5 is a diagram describing a method of configuring a digital filter apparatus according to an embodiment of the invention;

FIG. 6 is a block diagram describing a conventional configuration of the digital filter apparatus pertaining to the embodiment of the invention;

FIG. 7 is a block diagram describing a simple model according to an embodiment of the invention;

FIG. 8 is a diagram describing a method of configuring a digital filter apparatus according to an embodiment of the invention;

FIG. 9 is a diagram describing a method of configuring a digital filter apparatus according to an embodiment of the invention;

FIG. 10 is a block diagram of a digital filter apparatus according to an embodiment of the invention;

FIG. 11 is a system configuration diagram of a servo control system in an optical disk playback apparatus including a digital filter apparatus according to an embodiment of the invention; and

FIG. 12 is a block diagram of a conventional digital filter apparatus.

### DETAILED DESCRIPTION OF THE INVENTION

At least the following will become apparent from the description of the specification and the attached drawings. === Digital Filter apparatus (In the Case of Hardware Configuration) ===

<Overview>

The digital filter apparatus according to an embodiment of the invention comprises an IIR filter or an FIR filter configured by a DSP. Also, the digital filter apparatus according to the invention is used as a filter designed for a specific purpose whose filter characteristics are basically limited. In the following description, an example will be described where an IIR filter serving as the digital filter apparatus according to the invention is configured by a DSP capable of fixed-point arithmetic.

Also, in the digital filter apparatus according to the invention, the conventional multipliers for multiplying the digital input signal and/or the delay signals by the filter coefficients are replaced with later-described shift down units (401, 403, 441, 443) and/or later-described signal lines (445, 448) that transfer as is, or invert and transfer, the delay signals.

In configuring the digital filter apparatus according to the invention, the filter coefficients handled by the digital filter apparatus must be finite decimals in binary notation in order to replace the multiplication of the digital input signal and/or the delay signals by the filter coefficients with shift down processing.

For this reason, the filter coefficients and the filter order satisfying the required specification of the filter characteristics are determined based on the result of a simulation for designing the digital filter that was performed under the constraint that the filter coefficients are finite decimals in binary notation. For example, in the case of a band pass filter (BPF), the required specification of the filter characteristics is defined by a Q value representing the sharpness of the peak of the frequency characteristic, the cutoff frequency, the center frequency, and the attenuation characteristic of −6 dB/oct.

Below, a filter model configured using conventional multipliers based on predetermined filter coefficients and filter order will be called a “simple model”. Also, in the present invention, a digital filter apparatus that does not need a multiplier can actually be configured based on this simple model.

### EXAMPLE APPLIED TO LPF

<<Replacement with Shift Down Processing or the Like>>

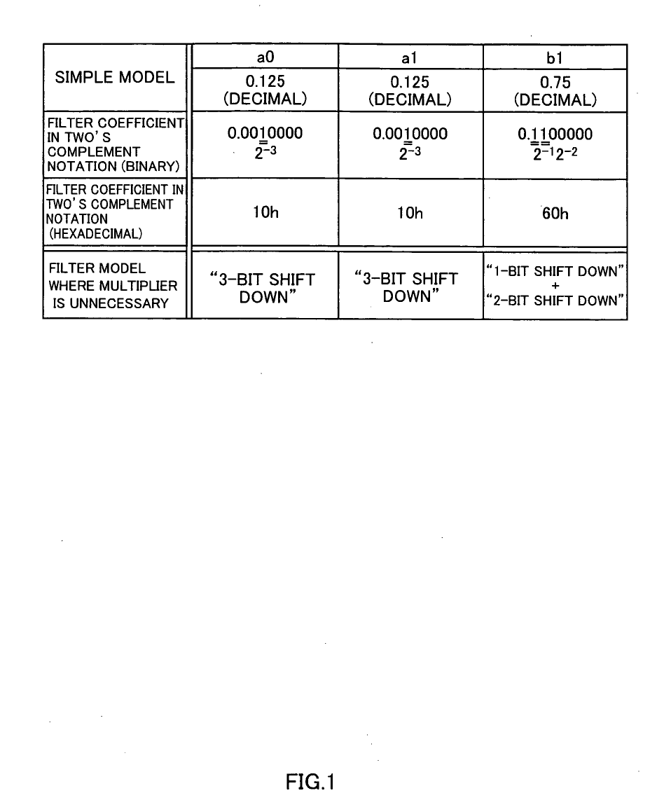

An example will be described based on FIGS. 1 to 3 where a low pass filter (LPF) serving as a digital filter apparatus according to an embodiment of the invention is constituted by a first order IIR filter. With respect to the specification of this LPF, the quantifying bit number is 16 bits, the sampling frequency Fs is 22.05 kHz, and the cutoff frequency is 1 kHz.

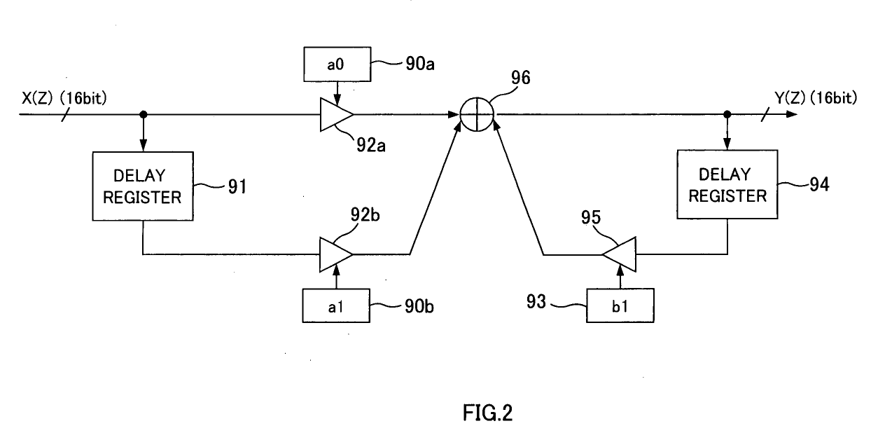

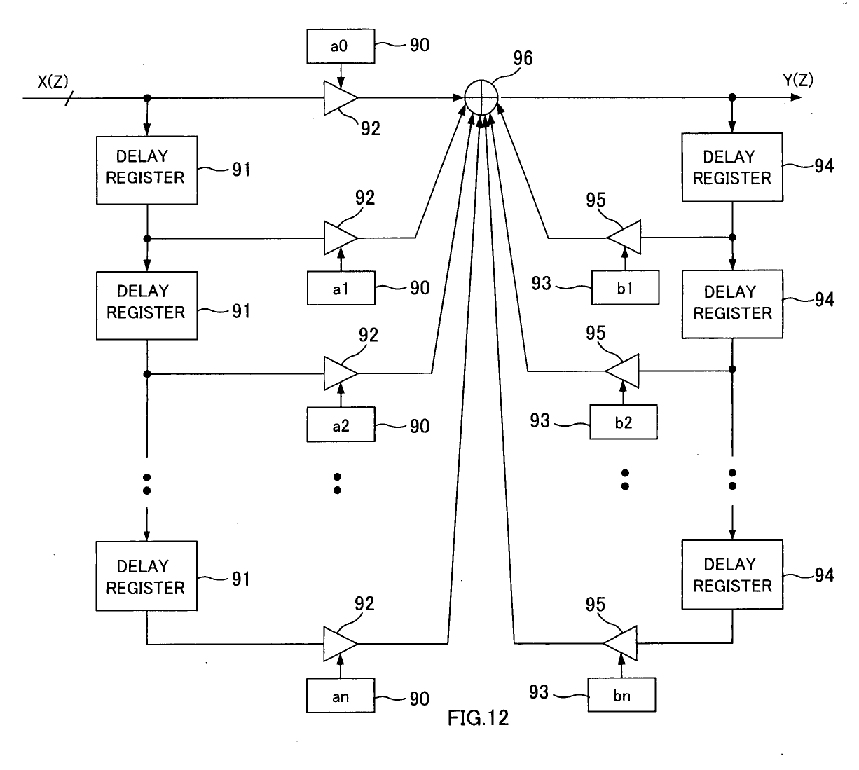

First, FIG. 2 shows a simple model of a predetermined first order IIR filter. In this simple model, the coefficient registers 90 and 93, the delay registers 91 and 94, the multipliers 92 and 95, and the adder 96 are the same as those in the conventional configuration shown in FIG. 12. The transfer function H(Z) of this simple model can be expressed as “H(Z)={a0+a1·Z\hat{ }(−1)}/{1+b1·Z\hat{ }(−1)}”. Also, as shown in FIG. 1, the filter coefficients a0, a1 and b1 are “0.125”, “0.125” and “0.75” in decimal notation, and become finite decimals when expressed in binary notation with a data length of 8 bits.

Here, the filter coefficients a0 and a1 are “0.0010000” in binary notation with a data length of 8 bits. Thus, the multiplication of the digital input signal X(Z) and the filter coefficient a0 in the multiplier 92a and the multiplication of the digital input signal X(Z) delayed one sampling period and the filter coefficient a1 in the multiplier 92b can be replaced with processing that shifts down by an equal number of bits to the absolute value “3” of the exponent “−3” with a base of “2” represented by the position of “1” in the decimal portion of the filter coefficients a0 and a1.

Also, the filter coefficient b1 is “0.1100000” in binary notation with a data length of 8 bits. Thus, the multiplication of the digital output signal Y(Z) delayed one sampling period and the filter coefficient b1 in the multiplier 95 can be replaced with processing that shifts down by equal numbers of bits to the absolute values “1” and “2” of the exponents “−1” and “−2” with a base of “2” represented by the position of “1” in the decimal portion of the filter coefficient b1. Namely, 1-bit shift down and 2-bit shift down are parallel-processed.

<<Hardware Configuration>>

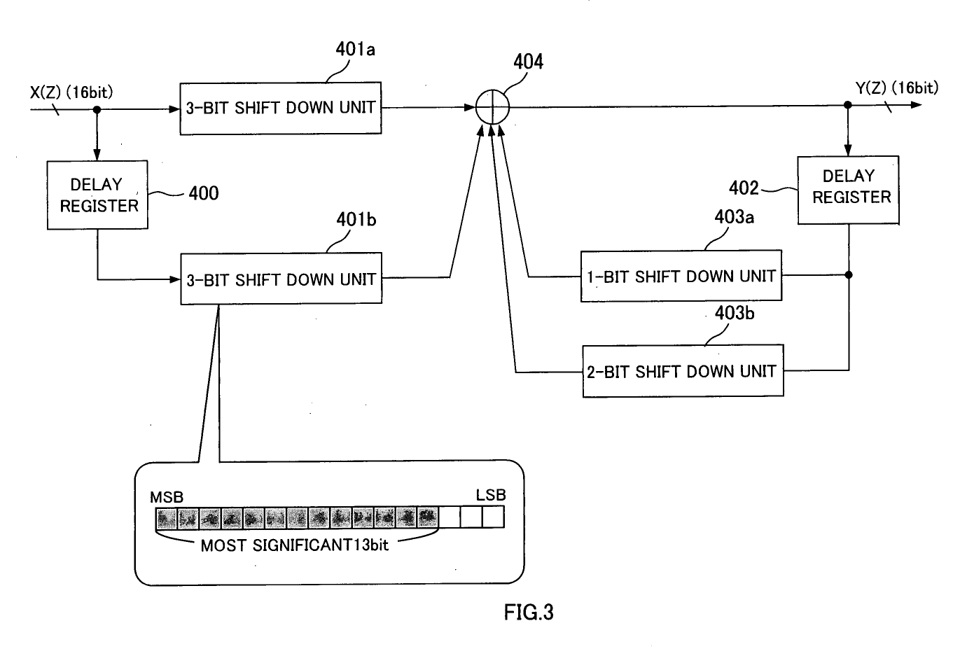

Thus, the LPF realized by the first order IIR filter according to the invention has the configuration shown in FIG. 3. In other words, the first order IIR filter comprises delay registers 400 and 402 (“delay processing units”), shift down units 401 and 403 (“filter coefficient processing units”), and an adder 404 (“addition processing unit”).

The delay register 400 is a register for delaying, by one sampling period, the digital input signal X(Z), and the delay register 402 is a register for delaying, by one sampling period, the digital output signal Y(Z). The adder 404 adds together the signals shift down-processed in the shift down units 401 and 403, and outputs the adding result as the digital output signal Y(Z).

The shift down unit 401a shifts down the digital input signal X(Z) by 3 bits in accordance with the filter coefficient a0, and the shift down unit 401b shifts down, by 3 bits and in accordance with the filter coefficient a1, the digital input signal X(Z) delayed one sampling period by the delay register 400. The shift down units 403a and 403b parallel-process, in accordance with the filter coefficient b1, the 1-bit shifting down and 2-bit shifting down of the digital output signal Y(Z) delayed one sampling period by the delay register 402.

The shift down units 401 and 403 can basically be constituted by 16-bit shift registers, but it is preferable for the shift down units 401b, 403a and 403b to perform shift down by removing a number of bits being shifted down from the least significant bit LSB of the 16-bit portion of the digital input signal X(Z) and the digital output signal Y(Z) stored in the delay registers 400 and 402. For example, the shift down unit 401b performs 3-bit shift down by acquiring the most significant 13 bits, that is, the difference between the 16 bits and the 3 bits being shifted-down of the 16-bit digital input signal X(Z) stored in the delay register 400. Thus, shift down can be realized suppressing an increase in the circuit scale in comparison to an instance where the shift down units 401b, 403a and 403b are constituted by shift registers.

In this manner, the first order IIR filter according to the invention uses the shift down units 401 and 403 rather than the conventional multipliers in the processing with the filter coefficients. Here, because the shift down units 401 and 403 simply perform only the shift down processing without complex processing such as accumulation and addition of the partial products, the circuit scale is extremely small compared with the conventional multipliers. Thus, a digital filter apparatus that is suited for integration, such as the aforementioned first order IIR filter, can be provided.

<Example Applied to BPF>

<<Replacement with Shift Down Processing or the Like>>

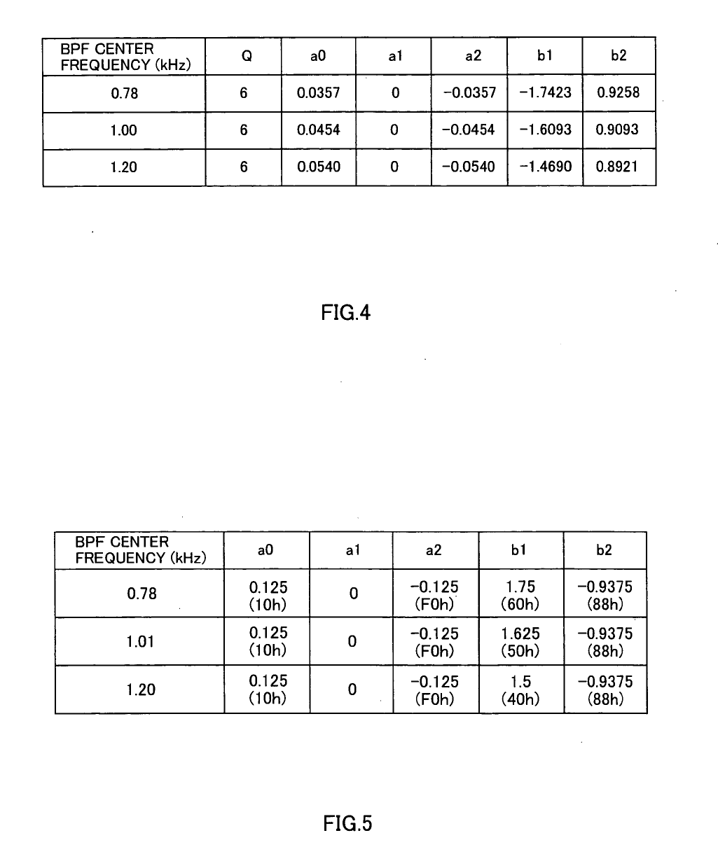

An example will be described based on FIGS. 4 to 10 where a BPF serving as the digital filter apparatus according to an embodiment of the invention is constituted by a second order IIR filter. With respect to the required specification of the BPF, the quantifying bit number is 16 bits, and the sampling frequency Fs is 11 kHz. As for the center frequency of the BPF, one can be selected from the three frequencies of 0.78 kHz, 1.00 kHz and 1.20 kHz that are unique from each other.

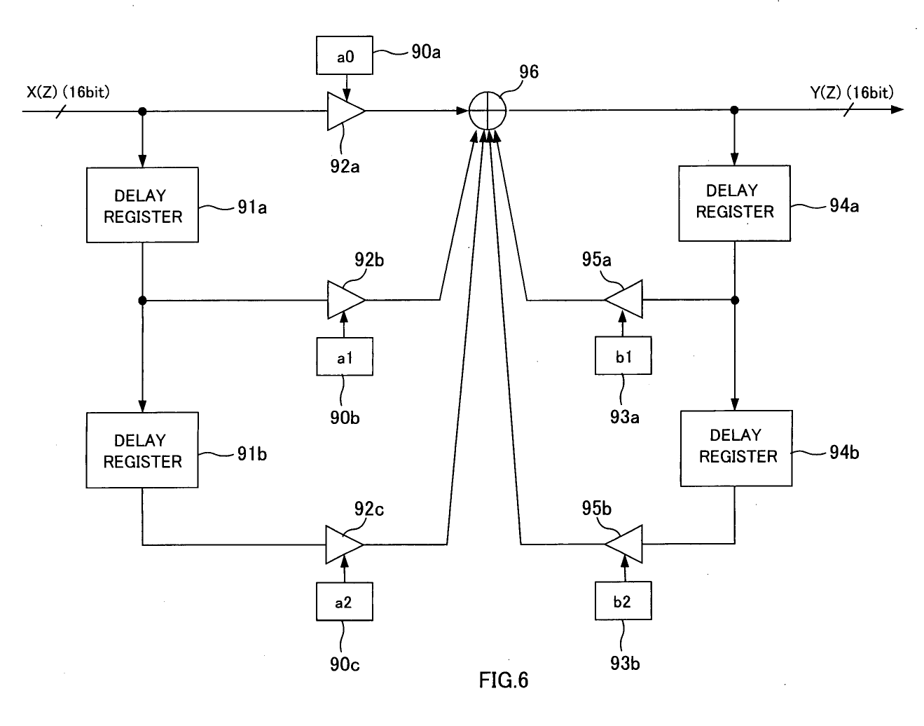

First, FIG. 6 shows a conventional configuration of a second order IIR filter according to the invention. In the conventional configuration shown in FIG. 6, the coefficient registers 90 and 93, the delay registers 91 and 94, the multipliers 92 and 95, and the adder 96 are the same as those shown in FIG. 12. The transfer function H(Z) of this BPF can be expressed as “H(Z)={a0+a1·Z\hat{ }(−1)+a2·Z\hat{ }(−2)}/{1+b1·Z\hat{ }(−1)+b2·Z\hat{ }(−2)}”. Also, the filter coefficients a0, a1, a2, b1 and b2 and Q for the center frequencies of 0.78 kHz, 1.00 kHz and 1.20 kHz are the values shown in FIG. 4, for example.

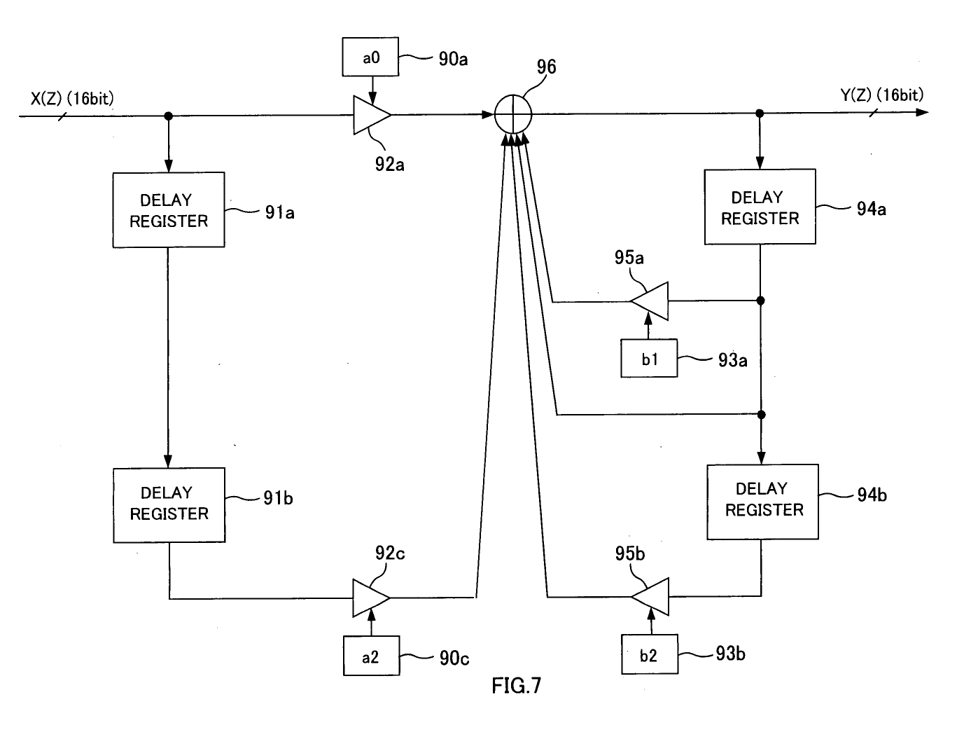

The filter coefficients a0, a1, a2, b1 and b2 shown in FIG. 4 are values in decimal notation, and when converted to binary notation, they do not become finite decimals but infinite decimals. Thus, a simple model where the filter coefficients a0, a1, a2, b1 and b2 become finite decimals in binary notation is determined on the basis of the result of executing a simulation for designing the digital filter. FIG. 7 shows the configuration of this simple model, and FIG. 5 shows the filter coefficients a0, a1, a2, b1 and b2 in this simple model.

Here, replacement of the multiplication with shift down processing relating to the filter coefficients a0, a2 and b2 in the simple model shown in FIG. 7 will be described based on FIG. 8. It will be noted that because the filter coefficient a1 is “0”, the signal line itself becomes unnecessary, so description thereof will be omitted. Also, the filter coefficients a0, a2 and b2 are the same in value for the center frequencies of 0.78 kHz, 1.01 kHz and 1.20 kHz.

First, the filter coefficient a0 is “0.125” in decimal notation, and becomes “0.0010000” in binary notation with a data length of 8 bits. Thus, the multiplication of the digital input signal X(Z) and the filter coefficient a0 in the multiplier 92a can be replaced with processing that shifts down by an equal number of bits to the absolute value “3” of the exponent “−3” with a base of “2” represented by the position of “1” in the decimal portion of the filter coefficient a0.

The filter coefficient a2 is “−0.125” in decimal notation. Here, when a number negative in decimal notation is expressed in binary notation, two's complement conversion is performed. Two's complement conversion of “−0.125” in decimal notation is realized by bit-inverting the binary notation “0.0010000” of the absolute value “0.125”, and adding “1” to the least significant bit LSB after bit inversion. Thus, two's complement of “−0.125” becomes “1.1110000”.

Thus, the multiplication of the digital input signal X(Z) delayed two sampling periods in the delay registers 91a and 91b and the filter coefficient a2 in the multiplier 92c can be replaced with 3-bit shift down processing that is the same as for the filter coefficient a0 and two's complement conversion that sequentially executes bit inversion and the addition of “1”.

Alternatively, the multiplication of the digital input signal X (Z) delayed two sampling periods and the filter coefficient a2 in the multiplier 92c can be replaced with parallel processing of inversion corresponding to “−1”, 1-bit shift down, 2-bit shift down, and 3-bit shift down on the basis of “1.1110000”, two's complement of “−0.125”. However, in this case, because the number of necessary shift down units increases and the circuit scale becomes large, it is preferable to use replacement with the aforementioned two's complement conversion.

Because the filter coefficient b2 is “−0.9375” in decimal notation, two's complement conversion is performed. Two's complement conversion of “−0.9375” in decimal notation is realized by bit-inverting the binary notation “0.1111000” of the absolute value “0.9375”, and adding “1” to the least significant bit LSB after the bit inversion. Thus, two's complement of “−0.9375” is “1.0001000”, which is a mixed decimal in which the integer portion is “−1”.

Thus, the multiplication of the digital output signal Y(Z) delayed two sampling periods by the delay registers 94a and 94b and the filter coefficient b2 in the multiplier 95b can be replaced with parallel processing of inversion corresponding to “−1” and then addition of “1” for two's complement conversion and processing that shifts down by an equal number of bits to the absolute value “4” of the exponent “−4” with a base of “2” represented by the position of “1” in the decimal portion in two's complement notation of the filter coefficient b2.

Alternatively, the multiplication of the digital output signal Y(Z) delayed two sampling periods and the filter coefficient b2 in the multiplier 95b can be replaced with parallel processing of 1-bit shift down, 2-bit shift down, 3-bit shift down, and 4-bit shift down, and the two's complement conversion that sequentially executing bit inversion after each shift down and addition of “1”. However, in this case, because the number of necessary shift down units increases and the circuit scale becomes large, it is preferable to use replacement with the aforementioned parallel processing of the inversion corresponding to “−1” and the 4-bit shift down.

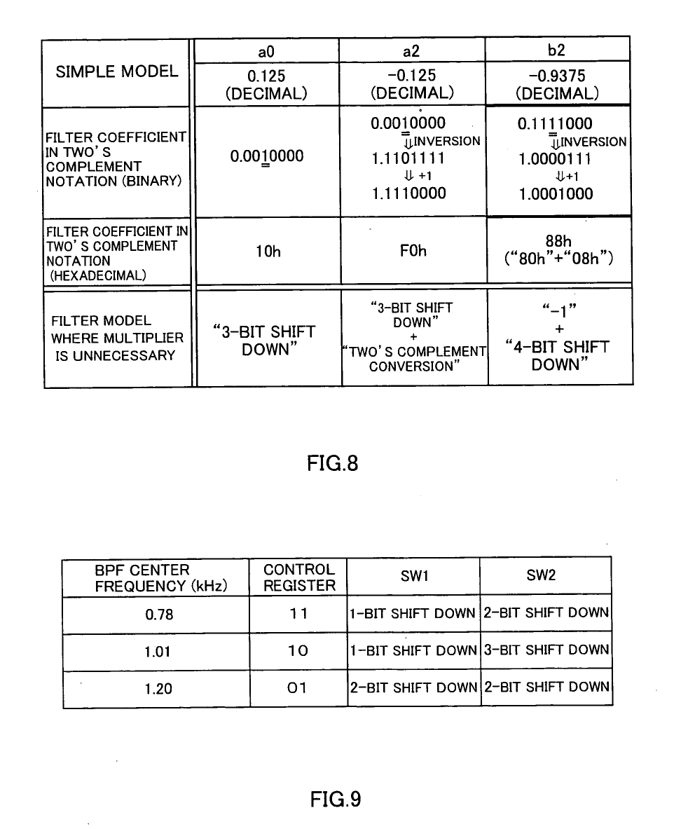

Next, the replacement of the multiplication with the shift down processing relating to the filter coefficient b1 in the simple model shown in FIG. 7 will be described based on FIG. 9. It will be noted the filter coefficient b1 takes on different values of “1.75” in decimal notation when the center frequency is 0.78 kHz, “1.625” in decimal notation when the center frequency is 1.01 kHz, and “1.5” in decimal notation when the center frequency is 1.20 kHz, respectively. Thus, because the filter coefficient b1 becomes mixed decimals whose integer portion is “1”, the simple model shown in FIG. 7 includes, the multiplier 95a that perform s multiplication of the delay output signal Y(Z) delayed one sampling period in the delay register 94a and the decimal portion of the filter coefficient b1 stored in the coefficient register 93a, and also, a signal line that supplies the adder 96 with the digital output signal Y(Z) delayed one sampling period in the delay register 94a as is. This signal line corresponds to the integer portion “1” of the filter coefficient b1.

First, the filter coefficient b1 is “1.75” in decimal notation when the center frequency is 0.78 kHz, and becomes “0.1100000” when the decimal portion “0.75” is expressed in binary notation with a data length of 8 bits. Thus, the multiplication of the digital output signal Y(Z) delayed one sampling period and the decimal portion of the filter coefficient b1 in the multiplier 95a can be replaced with processing that shifts down by equal numbers of bits to the absolute values “2” and 1” of the exponents “−2” and “−1” with a base of “2” represented by the positions of “1” in the decimal portion of the filter coefficient b1. Namely, 1-bit shift down and 2-bit shift down are parallel-processed. This state is represented as “11” in a later-described control register 450.

Similarly, the filter coefficient b1 is “1.625” in decimal notation when the center frequency is 1.01 kHz, and becomes “0.1010000” when the decimal portion “0.625” is expressed in binary notation with a data length of 8 bits. Thus, the multiplication in the multiplier 95a can be replaced with parallel processing of 1-bit shift down and 3-bit shift down. This state is represented as “10” in the later-described control register 450.

Similarly, the filter coefficient b1 is “1.5” in decimal notation when the center frequency is 1.20 kHz, and becomes “0.1000000” when the decimal portion “0.5” is expressed in binary notation with a data length of 8 bits. Thus, the multiplication in the multiplier 95a can be replaced with 1-bit shift down. It will be noted that in terms of the configuration of a later-described filter coefficient switching unit 452, the 1-bit shift down is replaced with parallel processing of 2-bit shift down. This state is represented as “01” in the later-described control register 450.

<<Hardware Configuration>>

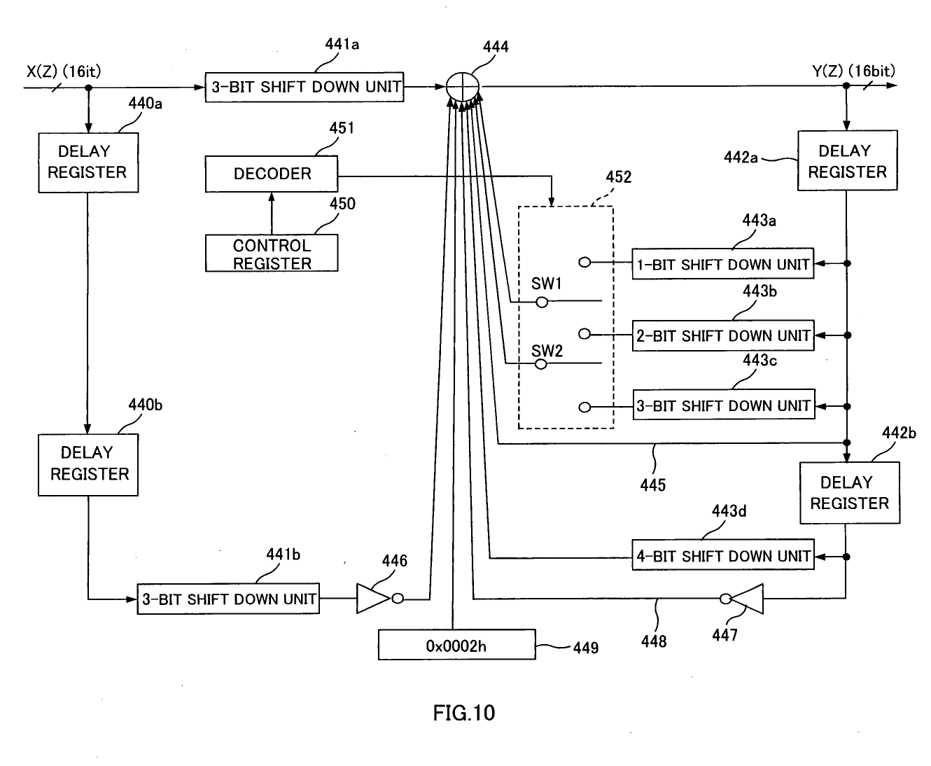

Thus, the BPF realized by the second order IIR filter according to the invention has the configuration shown in FIG. 10. In other words, the second order IIR filter comprises delay registers 440 and 442 (“delay processing units”), shift down units 441 and 443 (“filter coefficient processing units”), an inverter element 446 for two's complement conversion processing, a signal line 445 corresponding to the case where the integer portion of the predetermined filter coefficient is “1”, an inverter element 447 and a signal line 448 corresponding to the case where the integer portion of the predetermined filter coefficient is “−1”, a general register 449 for addition of “1” after bit inversion in two's complement conversion, a control register 450, a decoder 451, and a filter coefficient switching unit 452.

The delay register 440a is a register for delaying, by one sampling period, the digital input signal X(Z), and the delay register 440b is a register for further delaying, by one sampling period, the digital input signal X(Z) delayed in the delay register 440a.

The delay register 442a is a register for delaying, by one sampling period, the digital output signal Y(Z), and the delay register 442b is a register for further delaying, by one sampling period, the digital output signal Y(Z) delayed in the delayer register 442a.

The shift down unit 441a is a unit that shifts down the digital input signal X(Z) by 3 bits in accordance with the filter coefficient a0, and the shift down unit 441b is a unit that shifts down, by 3 bits in accordance with the filter coefficient a2, the digital input signal X(Z) delayed two sampling periods by the delay registers 440a and 440b.

It will be noted that the processing with the filter coefficient a2 sequentially executes the bit inversion and the addition of “1” in order to perform two's complement conversion after the 3-bit shift down as described above. Hence, the inverter element 446 is disposed on the signal line between the shift down unit 441b and an adder 444 for the bit inversion. In this case, the addition of “1” for two's complement conversion is performed by the logical value “2” being supplied to the adder 444 from the general register 449.

The shift down units 443a, 443b and 443c are units that shift down in relation to the filter coefficient b1 as shown in FIG. 9, and their outputs are supplied to the filter coefficient switching unit 452. The filter coefficient switching unit 452 includes two switches SW1 and SW2, and one of the shift down units 443a, 443b and 443c is selected in each of the switches SW1 and SW2 depending on the three types of center frequencies (0.78 kHz, 1.01 kHz, 1.20 kHz) for the BPF. The shift down-processed signals selected in the switches SW1 and SW2 are supplied to the adder 444.

It will be noted that the switching control of the switches SW1 and SW2 in the filter coefficient switching unit 452 is performed by the control register 450 and the decoder 451. As shown in FIG. 9, the control register 450 is set to one of “11” for the center frequency of the BPF being 0.78 kHz, “10” for the center frequency of the BPF being 1.01 kHz, and “01” for the center frequency of the BPF being 1.20 kHz. The decoder 451 decodes the 2 bits stored in the control register 450 and supplies, to the filter coefficient switching unit 452, a control signal for controlling the switching of the switches SW1 and SW2.

For example, when realizing a BPF whose center frequency is 0.78 kHz, the control register 450 is set to “11”. Then, on the basis of the “11” set in the control register 450, the decoder 451 supplies, to the filter coefficient switching unit 452, a control signal to cause the switch SW1 to select the shift down unit 443a and the switch SW2 to select the shift down unit 443b. As a result, in the filter coefficient switching unit 452, a signal shifted down 1 bit by the shift down unit 443a and a signal shifted down 2 bits by the shift down unit 443b are selected and supplied to the adder 444.

The shift down unit 443d is a unit that shifts down, by 4 bits in accordance with the decimal portion of the filter coefficient b2, the digital output signal Y(Z) delayed two sampling periods by the delay registers 442a and 442b. The inverter element 447 is an element that inverts, in accordance with the integer portion “−1” of the filter coefficient b2, the digital output signal Y(Z) delayed two sampling periods by the delay registers 442a and 442b. The bit-inverted signal is then supplied to the adder 444 via the signal line 448. It will be noted that in this case, the addition of “1” for two's complement conversion is performed by the logical value “2” being supplied to the adder 444 from the general register 449.

Namely, the processing relating to the filter coefficient b2 is realized by the 4-bit shift down processing in the shift down register 443d and the inversion in the inverter element 447 being performed in parallel.

The general register 449 is a register provided in order to allow the adder 444 to perform the addition of “1” after the bit inversion during the two's complement conversion associated with the filter coefficients a2 and b2 at one time. Namely, the logical value “2” is set in the general register 449, and this logical value “2” is supplied to the adder 444, and thereby the addition of “1” for two's complement conversion associated with the filter coefficients a2 and b2 can be concurrently completed.

In this manner, the second order IIR filter according to the invention uses the shift down units 441 and 443 rather than the conventional multipliers in the processing with the filter coefficients. Here, because the shift down units 441 and 443 simply perform only shift down processing without complex processing such as accumulation and addition of the partial products when compared with the conventional multipliers, the circuit scale is extremely small. Thus, according to the present invention, a digital filter apparatus that is suited for integration, such as the aforementioned second order IIR filter, can be provided. === Digital Filter apparatus (In the Case of Software Configuration) ===

In the digital filter apparatus according to the present invention, the shift down processing and the addition processing relating to the processing with the filter coefficients can also be realized with software.

For example, a case will be considered where “−0.5×0.6=−0.3”, multiplication of the delay signal of “−0.5” in decimal notation and the filter coefficient of “0.6” in decimal notation, is performed. It will be noted that because the delay signal “−0.51” is expressed as “CO(h)” in two's complement and hexadecimal notation and the filter coefficient “0.6” is expressed as “60(h)” in two's complement and hexadecimal notation, the multiplication “−0.5×0.6=−0.3” is expressed as “CO(h)×60(h)=D0(h)” in two's complement and hexadecimal notation.

Here, because the filter coefficient “60(h)” is expressed as “0.1100000=0.1000000+0.0100000” in binary notation with a data length of 8 bits, the processing with the filter coefficient“60(h)” can be realized by performing in parallel 1-bit arithmetic shift down corresponding to “0.1000000” and 2-bit arithmetic shift down corresponding to “0.0100000”.

Thus, because the delay signal “CO(h)” arithmetically shifted down one bit is “E0(h)” and the delay signal “CO(h)” arithmetically shifted down two bits is “F0(h)”, “CO(h)×60(h)” can be realized by the addition of “E0(h)+F0(h)”.

In this manner, because filter processing can be realized by a combination of basic arithmetic processes that is the arithmetic shift down plus the addition, the use of the function of a general arithmetic logic unit (ALU) of a microcomputer is sufficient for the filter processing, without a need for a special mechanism such as a DSP or multiplier capable of fixed-point arithmetic. Here, in a common control system, the DSP is configured to be in combination with a microcomputer, but by using the filter processing according to the present invention, the DSP or multiplier capable of fixed-point arithmetic becomes unnecessary in the control system, and thus the circuit scale can be reduced accordingly.

=== Filter for Servo Control ===

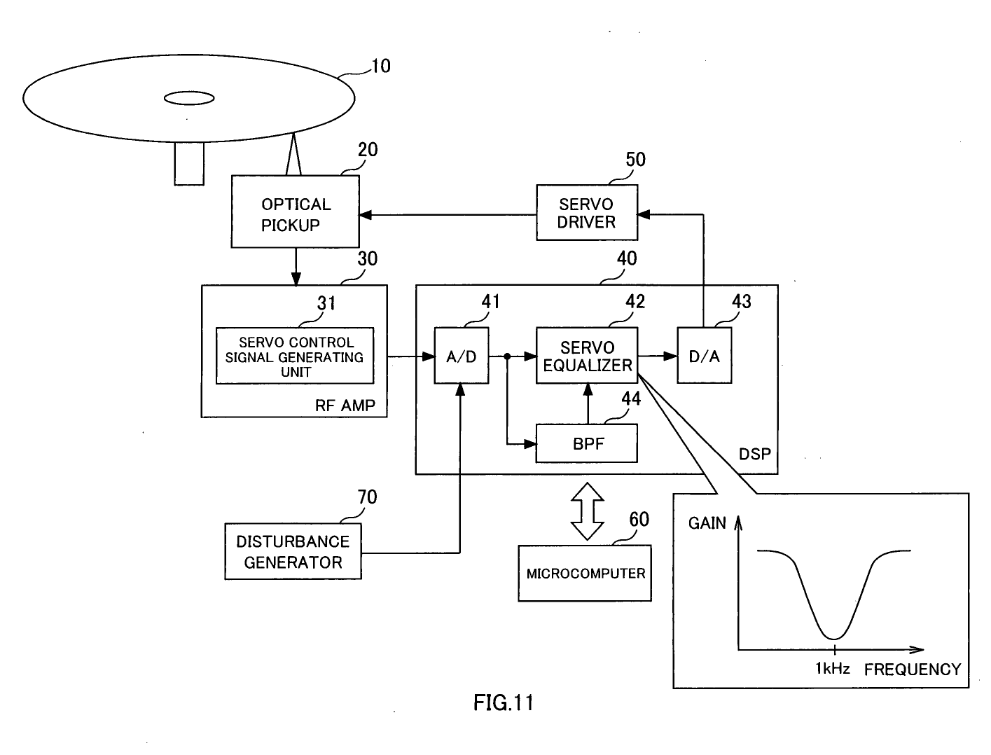

An embodiment will be described where the digital filter apparatus according to the present invention is applied to a servo equalizer and a gain adjustment filter that a servo control system of an optical disk playback apparatus includes. FIG. 11 is a system configuration diagram of a servo control system in an optical disk playback apparatus including the digital filter apparatus according to the present invention.

An optical pickup 20 includes a laser element, a light detector and an objective lens (none of which is shown), and is an electrical part that reads and writes information from and onto an optical disk 10 with laser light emitted from the laser element via the objective lens. The laser light emitted from the laser element is reflected by the recording surface of the optical disk 10 and then detected by the light detector.

An RF amp 30 is an amplifier that reproduces an RF signal by amplifying with a predetermined gain a light detected signal detected by the light detector of the optical pickup 20. The RF signal is decoded by a decoding processing unit that a DSP 40 includes, whereby playback of the information recorded on the optical disk 10 is performed. Usually, a servo control signal generating unit 31 for generating a servo control signal such as a tracking error signal and a focus error signal is incorporated in the RF amp 30.

Here, the tracking error signal is a control signal used in the tracking servo control to cause the laser light emitted from the optical pickup 20 to follow a target track when reading information recorded on the target track on the optical disk 10. The focus error signal is a control signal used in focus servo control to cause the objective lens of the optical pickup 20 to focus on the recording surface of the optical disk 10.

The DSP 40 performs digital signal processing for the optical disk such as a digital servo function and an encoding/decoding processing function. The DSP 40 includes, for digital servo function, an A/D converter 41 for converting to a digital signal the analog servo control signal generated by the servo control signal generating unit 31, a servo equalizer 42 which performs waveform shaping in gain adjustment, phase compensation, and the like on the A/D-converted servo control signal in order to stabilize servo control, and a D/A converter 43 which again converts to an analog signal the gain/phase-compensated digital servo control signal.

The analog servo control signal converted to by the D/A converter 43 is supplied to a servo driver 50, whereby tracking servo control and focus servo control are performed on the optical pickup 20. A microcomputer 60 controls the entire optical disk playback apparatus including the servo control system shown in FIG. 11.

Here, for a low frequency band, the servo equalizer 42 sets the gain to be high in order to absorb variations in the servo control signal associated with large variations in the optical pickup 20 itself, and for a medium frequency band (in the vicinity of 1 kHz), sets the gain to be low in order to remove variations in the servo control signal due to scratches on the optical disk 10, and for a high frequency band, sets the gain to be high in order to improve the capability to track minute variations when tracking. Namely, the servo equalizer 42 is a band elimination filter (BEF) that does not allow signals in a medium frequency band to pass.

The frequency characteristics of the servo equalizer 42 are predetermined in design by using a disturbance generator 70 and a BPF 44. For example the disturbance generator 70 generates a test sine wave of 1 kHz and supplies this to the A/D converter 41. At this time, the A/D converter 41 produces output wherein a digital signal corresponding to the sine wave of 1 kHz is superposed on the A/D-converted servo control signal. The output of the A/D converter 41 is supplied to the BPF 44, and the BPF 44 extracts the frequency component of 1 kHz and detects the gain of that frequency component. In other words, the frequency characteristics of the servo equalizer 42 are preset based on the gain of the frequency component detected by the BPF 44.

Here, the digital filter apparatus according to the present invention can be used for the BEF serving as the servo equalizer 42 or the BPF 44 for setting the gain of the servo equalizer 42. Hence, because the conventional multipliers become unnecessary in the processing with the filter coefficients in the servo equalizer 42 and the BPF 44, an increase in the circuit scale of the DSP 40 can be suppressed. Namely, according to the present invention, a digital filter apparatus suited for integration of the DSP 40 or the like can be provided.

Embodiments of the present invention have been described above, but the above embodiments are intended to facilitate understanding of the invention and should not be construed as limiting the invention. The present invention can be modified and improved without departing from the spirit and scope thereof, and equivalents are also included in the present invention.

1. A digital filter apparatus into which a digital input signal of plural bits is inputted in each predetermined period and which outputs a digital output signal that is a result of filter-processing the digital input signal in accordance with a predetermined filter coefficient and filter order, the digital filter apparatus comprising:
a delay processing unit to sequentially delay the digital input signal and/or the digital output signal in said each period in accordance with the filter order;
a filter coefficient processing unit to shift down, by an equal number of bits to the absolute value of an exponent represented by a position of “1” in a decimal portion of the filter coefficient that becomes a finite decimal when expressed in binary notation, each of the digital input signal and delayed signals processed by the delay processing unit; and
an addition processing unit that adds the signals processed by the filter coefficient processing unit and outputs the adding result as the digital output signal.

2. The digital filter apparatus of claim 1, wherein in a case where the filter coefficient is a mixed decimal including an integer portion of “1” or “−1”, when the integer portion is “1”, the filter coefficient processing unit supplies the digital input signal and/or the digital output signal as is to the addition processing unit, and
when the integer portion is “−1”, inverts the digital input signal and/or the digital output signal and supplies the inverted signals to the addition processing unit.

3. The digital filter apparatus of claim 1, wherein if the filter coefficient is negative, the filter coefficient processing unit performs the shift down based on one having a decimal portion with more positions of “1” in the bit series out of the filter coefficient not two's complement converted and the filter coefficient two's complement converted.

4. The digital filter apparatus of claim 1, wherein
the delay processing unit is a register that holds the digital input signal and/or the digital output signal during said each period, and
the filter coefficient processing unit performs the shift down by acquiring a series of most significant bits that is a difference between the plural bits and an equal number of bits to the absolute value of the exponent, in the digital input signal and/or the digital output signal stored in the register.

5. The digital filter apparatus of claim 1, further comprising a coefficient switching unit that, where a plurality of the filter coefficients are selectable for the predetermined filter order, switches between a plurality of the filter coefficient processing units provided respectively for the plurality of filter coefficients.

6. The digital filter apparatus of claim 1, wherein in order to add “1” after bit inversion in converting each filter coefficient, being negative, into a two's complement, the addition processing unit performs the addition of the “1” for the negative filter coefficients at one time.

7. The digital filter apparatus of claim 1, wherein the digital filter apparatus is a filter used in a servo equalizer to perform waveform shaping of a servo control signal in an optical disk playback apparatus.

8. A filter processing method for a digital filter apparatus into which a digital input signal of plural bits is inputted in each predetermined period and which outputs a digital output signal that is a result of filter-processing the digital input signal in accordance with a predetermined filter coefficient and filter order, the filter processing method comprising the steps of:
sequentially delaying the digital input signal and/or the digital output signal in said each period in accordance with the filter order;
shifting down, by an equal number of bits to the absolute value of an exponent represented by a position of “1” in a decimal portion of the filter coefficient that becomes a finite decimal when expressed in binary notation, each of the digital input signal and sequentially delayed signals; and
adding the shifted down signals and outputs the adding result as the digital output signal.
